(19) United States
(12) Patent Application Publication
(10) Pub. No.: US 2006/0027054 A1
(43) Pub. Date: Feb. 9, 2006

(54) Identification structure for a sleeve tool

(76) Inventor: Yao-Hung Wang, Tai-Ping City (TW)

Correspondence Address: CHARLES E. BAXLEY, ESQ., 90 JOHN STREET, THIRD FLOOR, NEW YORK, NY, 10038, US

(21) Appl. No.: 10/910,705

(22) Filed: Aug. 3, 2004

(51) Int. Cl. B25B 13/06; B25B 13/58

(52) U.S. Cl. 81/180.1; 81/121.1

(57) ABSTRACT

The present invention relates to an identification structure for a sleeve tool, on a surface of the sleeve is formed with an annular groove, a molding portion is formed on a bottom surface of the annular groove, and an identification unit is embossed on surface of the molding portion. The identification unit is so strongly structured that it will not be peeled off after a long time of usage, so as to prevent the customer from misreading the identification marks when choosing and buying the tools.

### BACKGROUND OF THE INVENTION

1. Field of the Invention

The present invention relates to a sleeve tool, and more particularly to an identification structure for a sleeve tool.

2. Description of the Prior Arts

Many tools are marked with trademarks, specification identifier or the like for helping the customer to recognize and select the desired tool easily from other tools during the purchasing process, so that the purchasing process is simplified. In addition, the producers can improve their reputation through the trademarks marked on the tool. Sleeve tool is one of the commonly used tools, however, trademarks or specification identifying marks on the existing sleeve tool have some problems that need to be solved as follows:

First, if the identifying marks are adhered to the peripheral surface of the sleeve tool through adhesive agent, since the peripheral surface of the sleeve tool is normally grainy so that the adhesive agent is unable to completely enter into the concaves between the grains, thus, the adhering force exerted on identifying marks with respect to the surface of the sleeve tool is weak so that the identifying marks is likely to fall off after a certain period of usage.

Second, if the identifying marks are painted on the peripheral surface of the sleeve tool by using spay paint, since the stability of the paint is poor, the identifying marks are likely to be blurred after being frequently touched by the user at normal temperature. On the other hand, the identifying marks are likely to be peeled off due to the adhering force of the spay paint with respect to the surface of the sleeve tool is limited.

The present invention has arisen to mitigate and/or obviate the afore-described disadvantages.

### SUMMARY OF THE INVENTION

The primary object of the present invention is to provide an identification structure for a sleeve tool, on the surface of the sleeve tool is embossed with an identification unit, so that the identification unit is strongly structured that it will not be peeled off after a long time of usage, so as to prevent the customer from misreading the identification marks.

To achieve this object, an identification structure for a sleeve tool is provided in accordance with the present invention, on a surface of the sleeve is formed with an annular groove, a molding portion is formed on a bottom surface of the annular groove, and an identification unit is embossed on surface of the molding portion.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of an identification structure for a sleeve tool in accordance with the present invention;

FIG. 2 is a partial amplified view for showing the identification structure in FIG. 1;

FIG. 3 is a partial cross sectional view of an identification structure for a sleeve tool in accordance with the present invention;

FIG. 4 is a partial amplified view of FIG. 3;

FIG. 5 shows a colorful layer is laminated on surface of the identification unit in accordance with the present invention.

### DETAILED DESCRIPTION OF THE PREFERRED EMBODIMENT

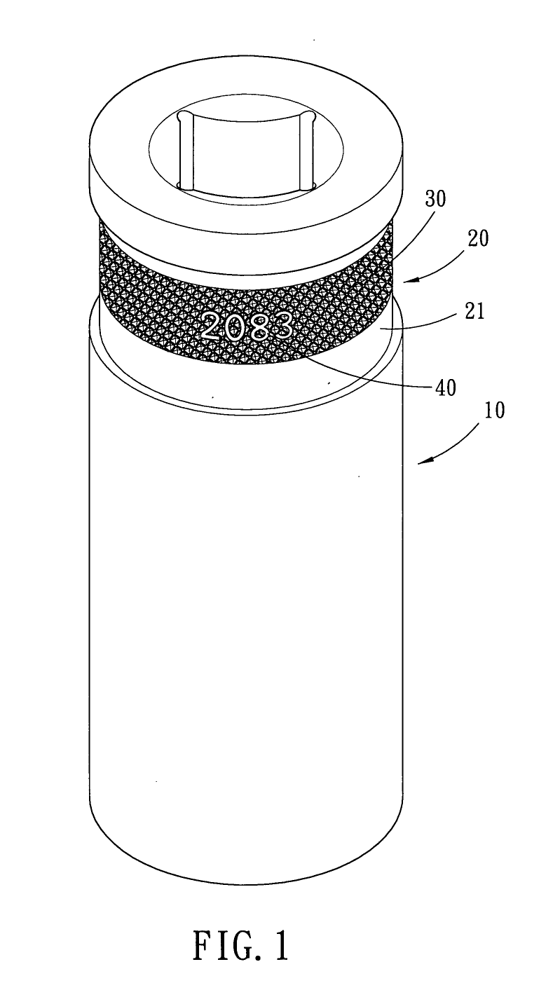

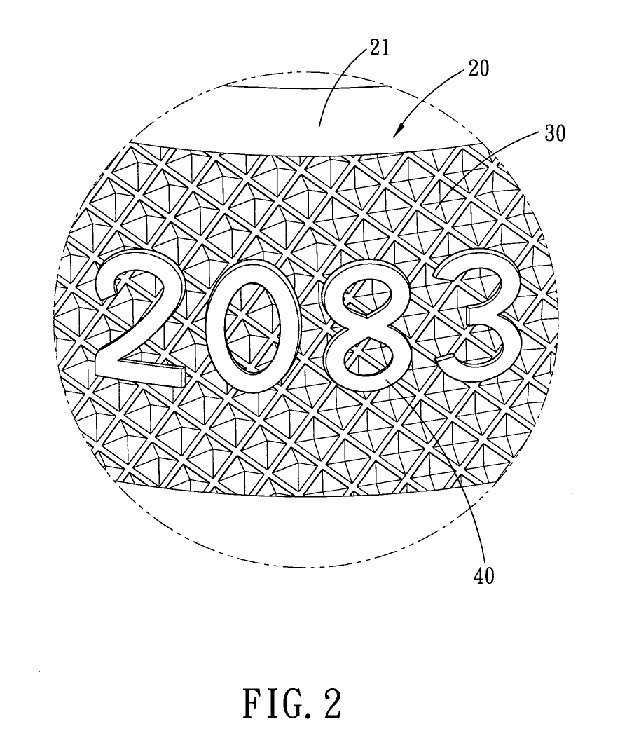

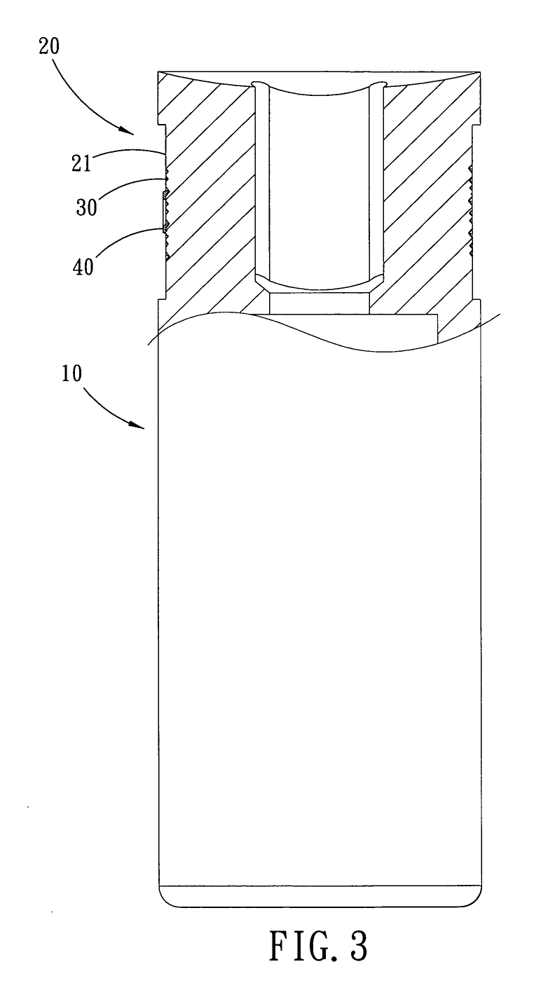

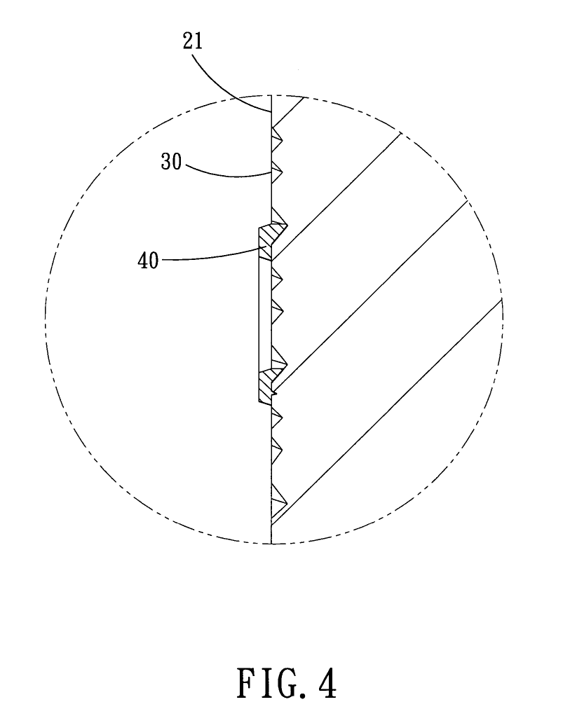

Referring to FIGS. 1-4, an identification structure for a sleeve tool in accordance with the present invention is shown and generally includes a sleeve 10, an annular groove 20, a molding portion 30 and an identification unit 40. The sleeve 10 is a general sleeve tool, at a predetermined position on the surface of the sleeve 10 is formed the annular groove 20. The molding portion 30 is formed on a bottom surface 21 of the annular groove 20 by texturing process so that the surface of the molding portion 30 is full of concaves and convexes. The identification unit 40 is embossed on the surface of the molding portion 30 in a manner that the cross section of the identification unit 40 is trapezoid-shaped and the identification unit 40 is integrally formed with the sleeve 10.

As mentioned above, the identification unit 40 is integrally formed on the bottom surface 21 of the annular groove 20 of the sleeve 10, so that the identification unit 40 is strongly structured and it will not be peeled off after a long period of usage, so as to prevent the customer from misreading the identification marks when purchasing the sleeve 10. On the other hand, since the identification unit 40 is integrally formed on the surface of the sleeve 10, the present invention is able to solve the problem caused by spraying paint on the surface of the sleeve tool, that is the identifying unit is likely to be blurred and peeled off after being frequently touched by the user at normal temperature.

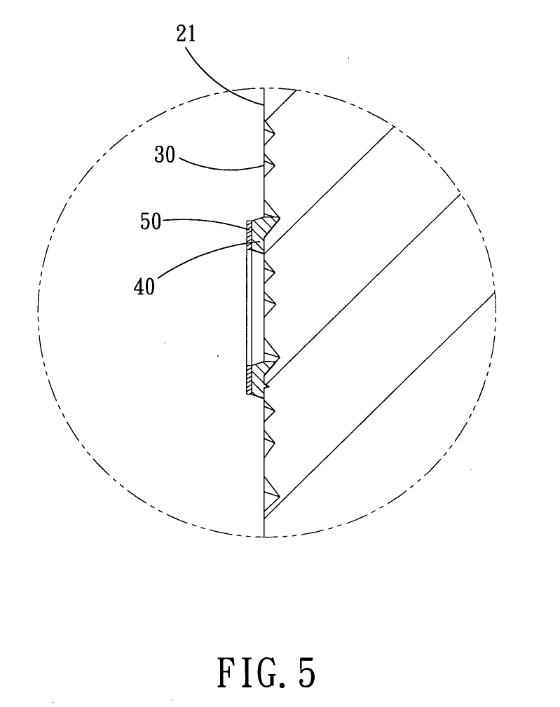

It is to be noted that, as shown in FIG. 5, a colorful layer 50 can be formed on the surface of the identification unit 40 by transfer-printing or screen-printing after the identification unit 40 is formed, so as to embody the identification unit 40.

While we have shown and described various embodiments in accordance with the present invention, it should be clear to those skilled in the art that further embodiments may be made without departing from the scope of the present invention.

1. An identification structure for a sleeve tool, on a surface of the sleeve formed with an annular groove, a molding portion formed on a bottom surface of the annular groove, and an identification unit embossed on surface of the molding portions;
the molding portion is formed by texturing process, the surface of the molding portion is convex and concave shaped, and the identification unit is trapezoid-shaped in cross section.

2. (canceled)

3. The identification structure for a sleeve tool as claimed in claim 1, wherein a colorful layer is laminated on surface of the identification unit.

4. (canceled)
